(19) United States
(12) Patent Application Publication
(10) Pub. No.: US 2006/0173710 A1
(43) Pub. Date: Aug. 3, 2006

(54) System and user interface supporting item ordering for use in the medical and other fields

(76) Inventor: Tobias Komischke, Phoenixville, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/190,568

(22) Filed: Jul. 27, 2005

Related U.S. Application Data
(60) Provisional application No. 60/648,461, filed on Jan. 31, 2005.

(51) Int. Cl. G06Q 10/00; G09G 5/02

(52) U.S. Cl. 705/2; 345/594

(57) ABSTRACT

A User Interface (UI) system allows a user to select treatment orders efficiently and to search and select particular treatment orders with a reduced number of navigation actions for completion of a physician treatment order, for example. A user interface system enables a user to select items for addition to a treatment order list, the items being for use in treating a patient. The system comprises a display processor for initiating generation of data representing a treatment order selection window. The image window includes, multiple user selectable buttons corresponding to multiple user selectable treatment order categories and having locations remaining fixed within the treatment order selection window. The image window includes a search field image element for searching a treatment order category associated with a currently selected button of the multiple user selectable buttons to find a treatment order item in response to user entry of a search term in the search field. The image window also includes an image area for displaying data identifying treatment order items associated with at least one of, (a) the search term and (b) the treatment order category associated with the currently selected button.

This is a non-provisional application of provisional application Ser. No. 60/648,461 by T. Komischke filed Jan. 31, 2005.

### FIELD OF THE INVENTION

This invention concerns a user interface system enabling a user to select items for addition to an order list that are usable in treating a patient, for example.

### BACKGROUND OF THE INVENTION

Existing User Interface systems and associated dialog menus supporting ordering of treatment for a patient offer limited search, browsing and filtering capability of items for selection by a Physician in treating a patient, for example. Further, existing systems are overly complex and provide a confusing array of methods supporting search of items for order. The inventor has advantageously recognized the need for an efficient User Interface ordering menu offering the flexibility to locate desired order items in an efficient user friendly manner without confusing the user with superfluous ordering menus and arrangements. A system according to invention principles addresses these requirements and associated problems.

### SUMMARY OF INVENTION

A User Interface (UI) system provides efficiently navigable treatment ordering dialog images including ordering function elements located in a consistent fixed position in different image windows and enabling a user to efficiently search for specific orders from a comprehensive order catalogue to select and append orders to existing orders already initiated for a patient. A user interface system enables a user to select items for addition to a treatment order list, the items being for use in treating a patient. The system comprises a display processor for initiating generation of data representing a treatment order selection window. The image window includes, multiple user selectable buttons corresponding to multiple user selectable treatment order categories and having locations remaining fixed within the treatment order selection window. The image window includes a search field image element for searching a treatment order category associated with a currently selected button of the multiple user selectable buttons to find a treatment order item in response to user entry of a search term in the search field. The image window also includes an image area for displaying data identifying treatment order items associated with at least one of, (a) the search term and (b) the treatment order category associated with the currently selected button.

### BRIEF DESCRIPTION OF THE DRAWING

FIG. 1 shows a networked hospital information system employing a user interface system, according to invention principles.

FIG. 2 shows a user interface treatment order selection window enabling a user to select treatments for order for a patient, according to invention principles.

FIGS. 3 and 4 show alternative embodiments of user interface treatment order selection windows enabling a user to select treatments for order for a patient, according to invention principles.

FIGS. 5-9 show configurations of the user interface treatment order selection window of FIG. 1 together with an image window showing current treatment orders already placed for a patient, according to invention principles.

FIG. 10 shows a flowchart of a process for providing a user interface, according to invention principles.

### DETAILED DESCRIPTION OF THE INVENTION

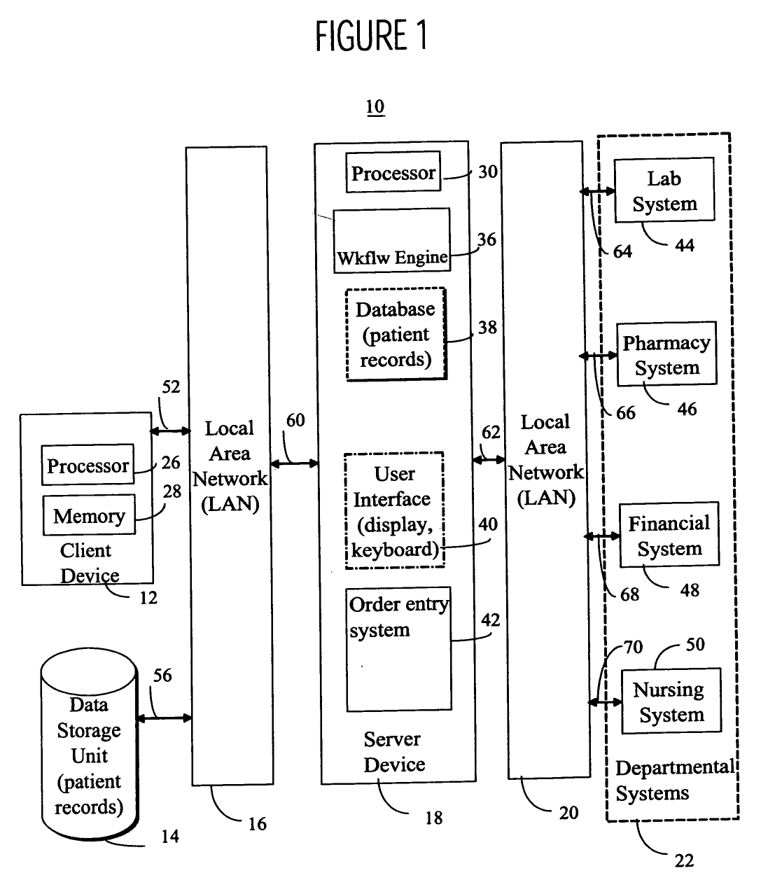

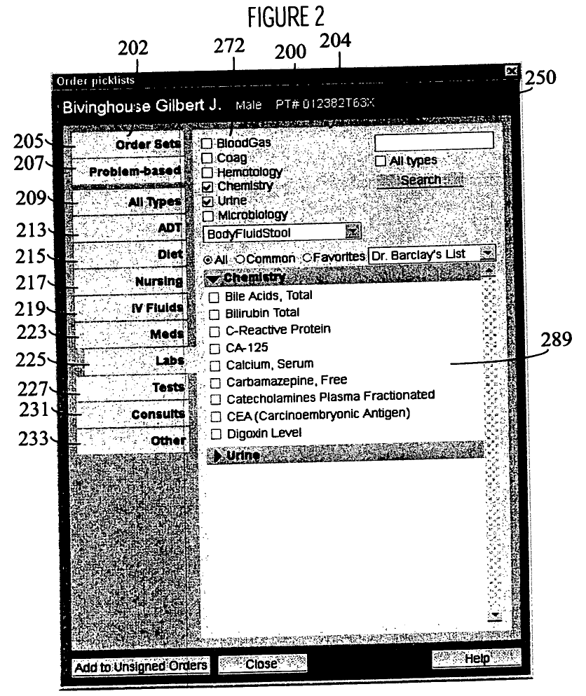

FIG. 1 shows a networked hospital information system employing a user interface system providing a dialog menu (shown in FIG. 2) enabling a user to efficiently search for specific treatment orders from a comprehensive treatment order catalogue and to select and append orders to existing orders already initiated for a patient. In a first embodiment the system dialog menu supports efficient user navigation to find a desired treatment from a catalog of available treatments. The system requires a reduced number of user navigation and scrolling commands to search for and identify a desired treatment order. A user interface image advantageously dynamically displays information items that provide a user with a reduced reading load whilst supporting efficient user navigation to find a desired treatment order. In another embodiment the system provides a user interface image consolidating and integrating functions together (using a search engine initiated via user selectable button on a button row, for example). This embodiment employs user interface elements that are located at a fixed image position during user navigation through different treatment order search and selection images and also uses an increased dialog menu size.

An individual hospital typically has a catalog of predetermined orders for treatments used by physicians in selecting treatment for a particular patient. The catalog may contain several thousand individual orders. A physician needs to find a particular treatment order to be used for a particular patient from a large number of possible orders. The system streamlines browsing and searching for order items using a dialog menu exemplified FIG. 2 that is substantially larger than the dialog menus typically used in existing user interface systems. The existing user interface systems also typically do not have user interface elements located permanently in the same fixed location. The existing systems, as a consequence, require relatively extensive scrolling by a user through lists to find a desired line item (i.e., a treatment order).

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

FIG. 2 shows a user interface order selection window 200 including button column 202 comprising user selectable buttons 205-233 associated with corresponding treatment order related categories. Image window 200 also includes image window 204 enabling a user to select treatments for order for a patient identified in row 250. Further, the content of image window 204 is updated and altered in response to user selection of a button in column 202. Row 250 at the top of the dialog menu includes patient demographic data including patient name, gender and patient identification number.

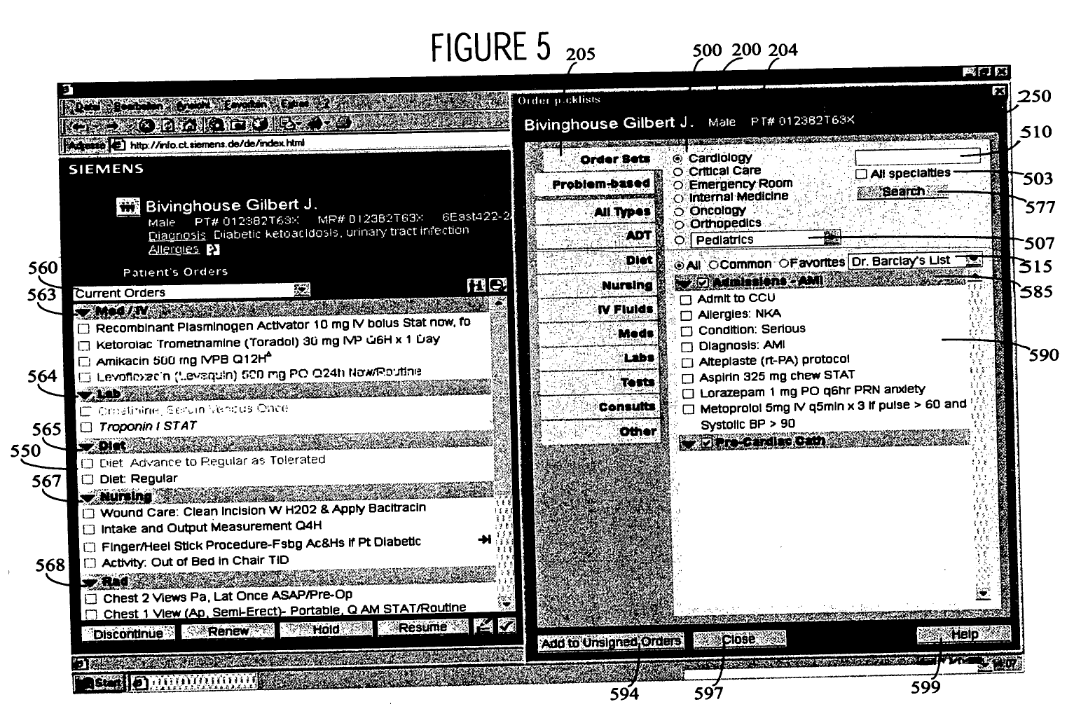

FIG. 5 shows image window 200 advantageously concurrently presented together with (and side-by-side) image window 550 whereby both windows occupy approximately half the screen area Image window 550 shows existing treatment orders 560 already selected for a particular patient identified in row 250 and signed by a physician. Image window 200 includes window 204 enabling a user to select treatments for addition to existing treatment orders in window 550 for the particular patient. Existing treatment orders for the particular patient include categories comprising medication orders 563, laboratory orders 564, dietary orders 565, nursing orders 567 and radiology orders 568, for example. Image window 204 illustrates menu content generated in response to user selection of order sets button 205 enabling a user to find a desired treatment order set. An order set is analogous to an order folder comprising a group of individual treatment orders having a single group name. The order sets content of image window 204 includes a list of user selectable physician specialties 500 (e.g., cardiology selected via user selectable option list 507) where items can be selected to show orders associated with one or more physician specialties.

The system advantageously employs a search engine enabling a user to initiate a search via button 577 for a treatment order or order set within user selected specialties based on search criteria entered via data entry box 510. The search engine is context-sensitive and searches data representing treatment orders selected by a user via list 500 unless a user selects all specialties item 503 in which case all available specialties are searched. In the FIG. 5 image, a search is performed in Cardiology specialty orders unless the all specialties item 503 is selected. Moreover a user is further able to filter treatment order search results via selection of items in row 515. Specifically, a user is able to select “All” (show all), “Common” (show the most frequently used orders) or “Favorites” (show the user or user's group preferred orders). A user selects the particular preferred orders via an option list in row 515 (here showing all orders and order sets related to cardiology are selected). A displayed result image section 590 shows a search result list of order sets in response to user selected filter and search criteria. The individual orders and components of an order set identified by a search are displayed in image window section 590 in response to user selection of a treatment order set title or header (e.g., title 585) and the consequent expansion of the order set header item. The opened order item 585 is collapsed in response to a second subsequent user selection of the treatment order set title or header. Orders in window 590 may be individually selected by a user and added to current orders in window 550 signed by a physician and further order processing, in response to selection of button 594. Button 597 is usable to close menu 200 and button 599 is used to initiate a help dialog menu.

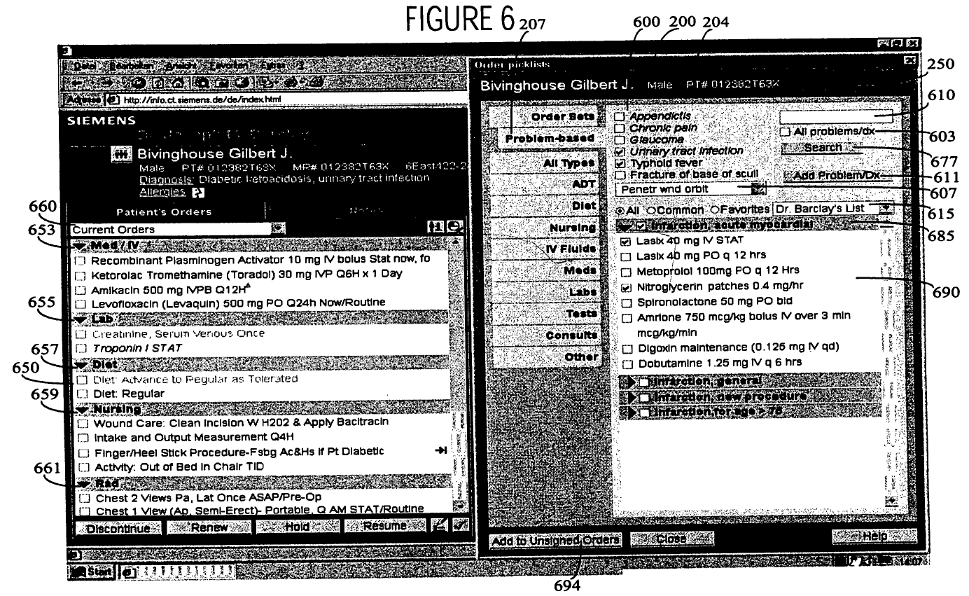

FIG. 6 shows image window 200 advantageously concurrently presented together with (and side-by-side) image window 650 whereby both windows occupy approximately half the screen area. Image window 650 shows existing treatment orders 660 already selected for a particular patient identified in row 250 and signed by a physician. Image window 200 includes window 204 enabling a user to select treatments for addition to existing treatment orders for the particular patient. Existing treatment orders for the particular patient include categories comprising medication orders 653, laboratory orders 655, dietary orders 657, nursing orders 659 and radiology orders 661, for example. Image window 204 illustrates menu content generated in response to user selection of problem based orders button 207 enabling a user to find a desired treatment order set based on already assessed problems and/or diagnoses of a patient. The order sets content of image window 204 includes a list 600 of items (e.g. Penetr wnd orbit selected via user selectable option list 607) representing problems and diagnoses that are user selectable to find associated orders. In list 600 problems are identified by italic font and diagnoses by regular font.

A context-sensitive search engine activated via button 677 in the FIG. 6 user interface image (in similar fashion to the FIG. 5 search) searches data representing treatment orders selected by a user via list 600 unless a user selects all problems/dx item 603 in which case all available problems and diagnoses are searched. In the FIG. 6 image, a search is performed in Urinary tract infection and Typhoid fever orders unless the problems/dx item 603 is selected. Moreover a user is further able to filter treatment order search results via selection of items in row 615. Specifically, a user is able to select “All” (show all), “Common” (show the most frequently used orders) or “Favorites” (show the user or user's group preferred orders). A user selects the particular preferred orders via an option list in row 615 (here showing all orders and order sets related to urinary tract infection and typhoid fever are selected). A displayed result image section 690 shows a search result list of order sets in response to user selected filter and search criteria. The individual orders and components of an order set identified by a search are displayed in expanded or collapsed mode in image window section 690 in response to user selection of a treatment order set title or header (e.g., title 685) as previously explained in connection with FIG. 5. Orders in window 690 may be individually selected by a user and added to current orders in window 650 in response to user selection of button 694. A user selects button 611 to initiate generation of a dialog menu that allows a user to add problems and diagnoses to the current problems and diagnoses list of the patient identified in row 250.

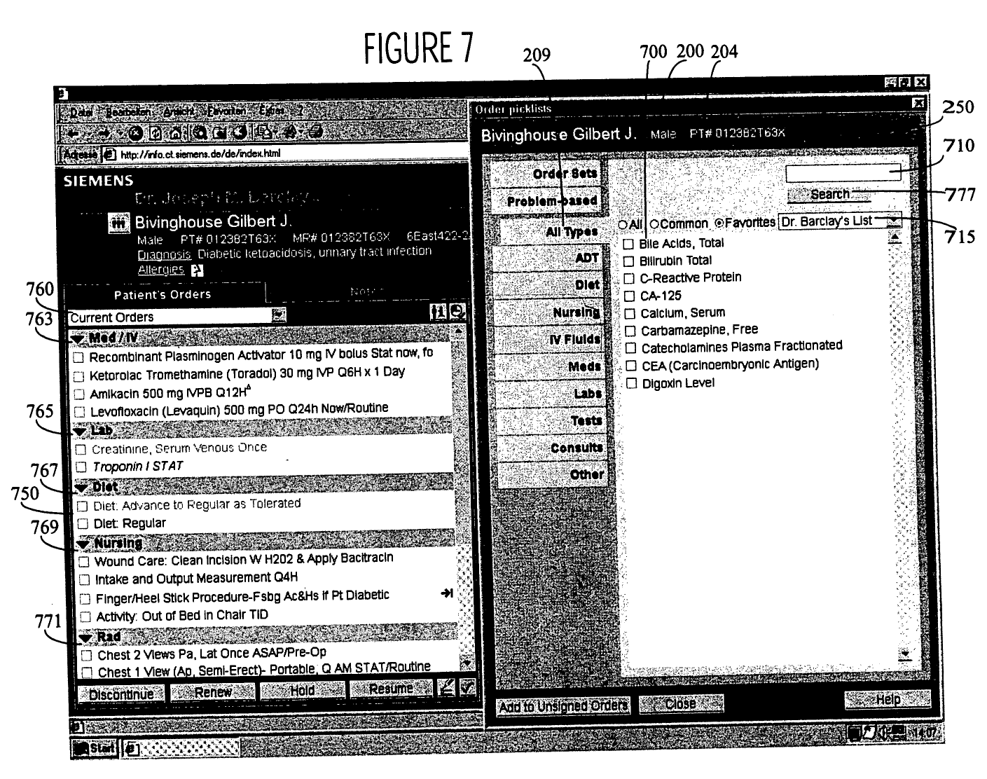

In similar fashion to FIGS. 5 and 6, FIG. 7 shows image window 200 advantageously concurrently presented together with (and side-by-side) image window 750 showing existing treatment orders 760 (including order categories 763-771) already selected for a particular patient identified in row 250 and signed by a physician. Image window 200 includes window 204 enabling a user to select treatments for addition to existing treatment orders for the particular patient. Image window 204 illustrates menu content generated in response to user selection of All types of orders button 209 enabling a user to find a desired treatment order set and/or individual orders across the different order types based on clinical classifications of orders, e.g. Medications, Laboratory Tests, Radiology Orders, etc. The order sets content of image window 204 includes a list 700 of items. A context-sensitive search engine is activated via button 777 and searches data representing treatment orders selected by a user via list 700 and to filter treatment order search results via selection of items in row 715.

Similarly, image window 204 (FIG. 2) presents menus corresponding to user selection of ADT (Admission, Discharge & Transfer) button 213, Diet button 215 through to Others orders buttons 233. An individual menu 204 enables a user to find a desired treatment order set in a selected order type in list 202 FIG. 2 and within a sub-type of the selected type in list 272 in response to user selection of an item in list 272 indicating associated orders. A context-sensitive search engine and filter functions are used to find a desired treatment order as described in connection with FIGS. 5-7.

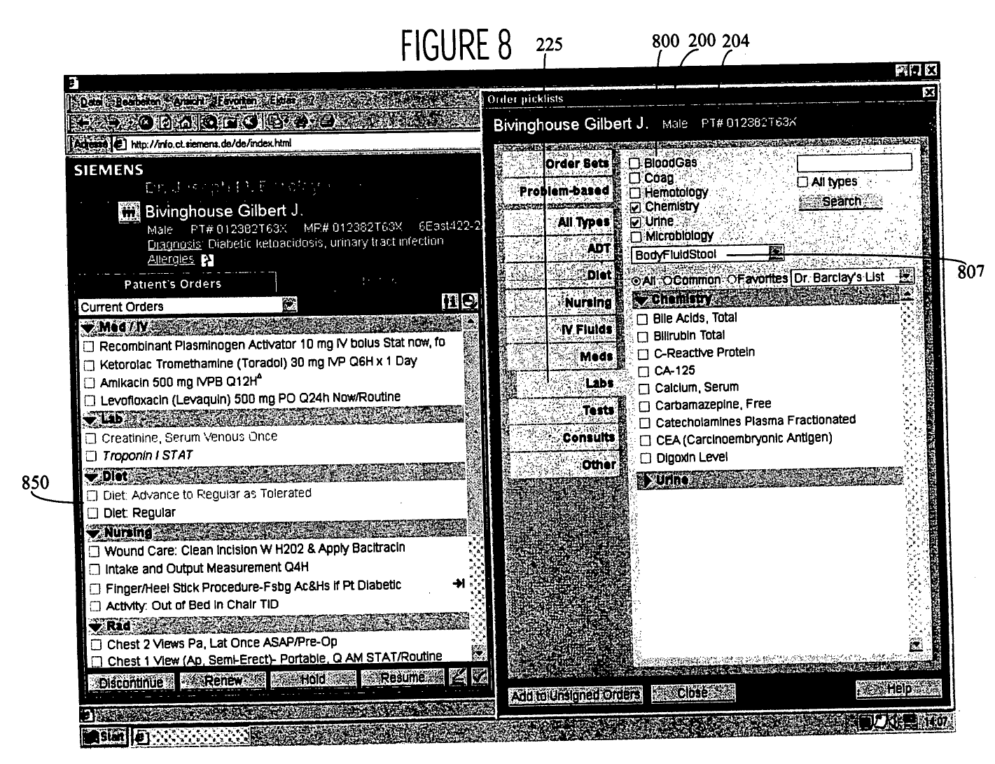

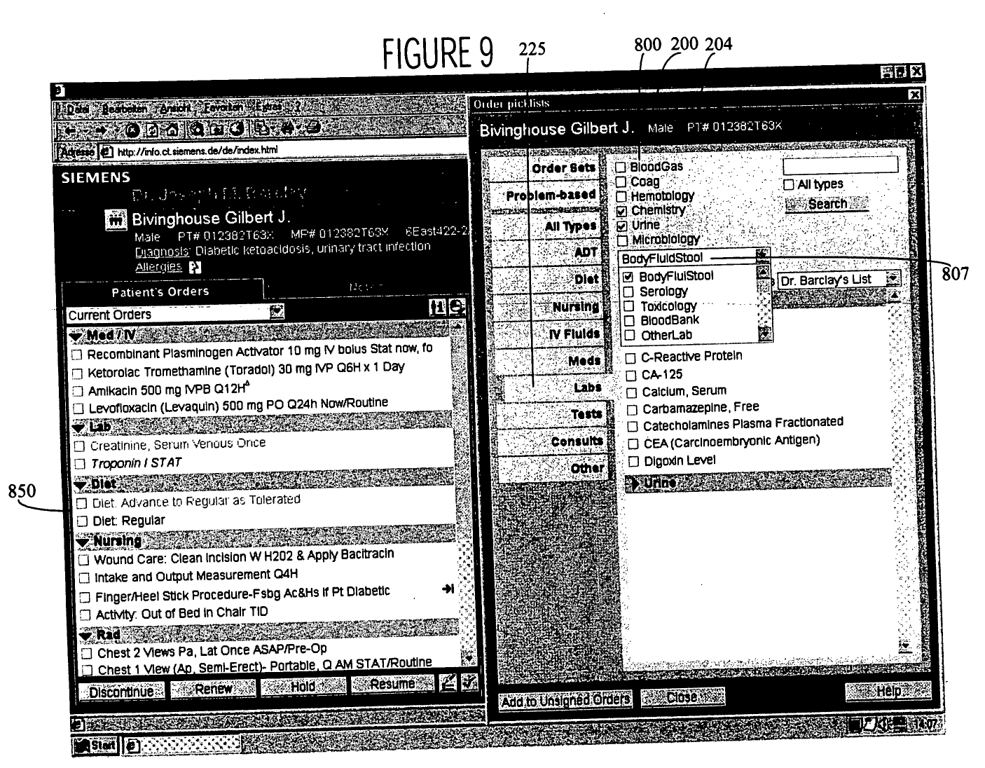

FIGS. 8 and 9 show image window 200 advantageously concurrently presented together with (and side-by-side) image window 850 showing existing selected treatment orders for a patient signed by a physician. Image window 200 in FIG. 8 includes window 204 illustrating a menu generated in response to user selection of laboratory orders button 225 enabling a user to find a desired laboratory test treatment order set and/or individual orders. Image window 204 includes a list 800 of items selectable by a user and including an item selectable via option list 807. FIG. 9 further illustrates items selectable via option list 807.

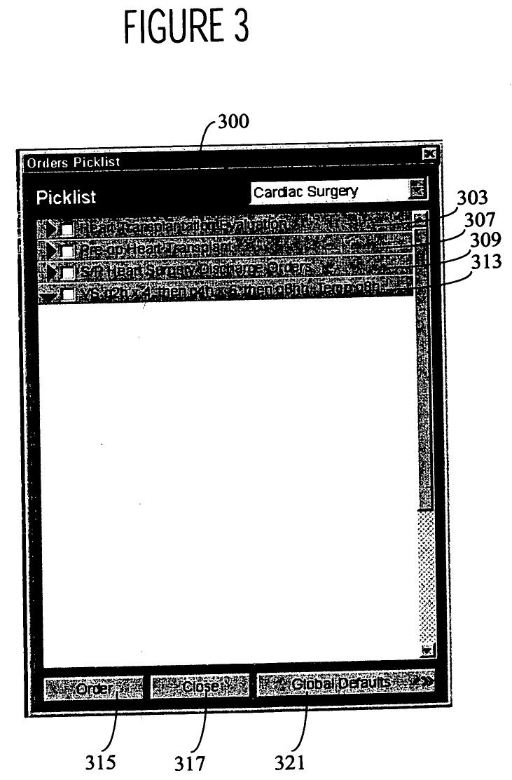

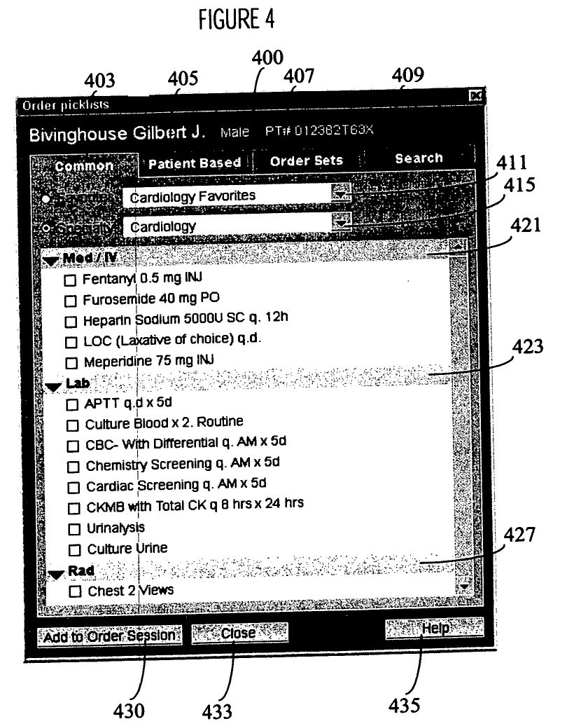

FIGS. 3 and 4 show user interface order selection windows 300 and 400 respectively, which may be substituted for image window 200 in FIGS. 5-9 as alternative embodiments. Image windows 300 and 400 enable a user to select treatments for order for a patient though they offer fewer advantages than UI image window 200 in FIGS. 2 and 5-9. The FIG. 3 UI image display illustrates a nurse treatment ordering menu. Window 300 presents treatment order sets 303, 307, 309 and 313 comprising multiple orders (not shown). Treatment order sets 303, 307, 309 and 313 are expandable in response to user selection of a corresponding title label and are also subsequently collapsible in response to user selection of the corresponding title label. Image window 300 enables a user to select an order set such as set 303, 307, 309 and 313 as a whole or individual orders and to add the orders to existing treatment orders already selected for a particular patient and awaiting physician signature in response to user selection of button 315. Button 317 is employed by a user to close menu 300 and button 321 is employed by a user to initiate presentation of global default treatment orders from different order types.

The FIG. 4 UI image display illustrates a physician treatment ordering menu. Window 400 includes buttons 403, 405, 407 and 409. Buttons 403 and 405 enable a user to present menus supporting user selection of treatment orders categorized as common or patient based. Button 407 enables a user to present a menu supporting user selection of treatment order sets categorized by specialty and/or order type (e.g., types like those shown in list 202 of FIG. 2). Button 409 enables a user to present a menu supporting user initiated search across selectable order types and categories. Option lists 411 and 415 enable a user to view and select particular treatment order sets (and individual orders) such as order set categories 421, 423 and 427 based on preference or specialty, for example. Image window 400 enables a user to select, an order set as a whole, or individual orders for addition to existing treatment orders already selected for a particular patient and awaiting physician signature in response to user selection of button 430. Button 433 is employed by a user to close menu 400 and button 435 is employed by a user to initiate presentation of a help dialog menu.

FIG. 1 shows a networked hospital information system employing UI display image windows as illustrated in FIGS. 2-9 enabling treatment order search and selection functions as previously described in connection with these Figures. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

User interface system 40 operating in conjunction with order entry system 42 provides the treatment search and selection menus and functions of FIGS. 2-9 and is located in server 18. User interface system 40 includes a search engine providing a treatment order search function in response to user command via displayed menus. Server device 18 permits multiple users to employ the treatment order search and selection menus at multiple client devices. In another embodiment user interface system 40 and system 42 are located in client device 12. User interface system 40 includes an input device that permits a user to provide information to client device 12 and an output device that provides a user a display of the multi-row tabbed menus and other information. Preferably, the input device is a keyboard and mouse, but also may be a touch screen or a microphone with a voice recognition program, for example. The output device is a display, but also may be a speaker, for example. The output device provides information to the user responsive to the input device receiving information from the user or responsive to other activity by client device 12. For example, the display presents information responsive to the user entering information in the client device 12 via a keyboard.

Server device 18 includes processor 30, Workflow Engine 36, database 38 including patient records and patient treatment plans, UI system 40 and order entry system 42. Server device 18 may be implemented as a personal computer or a workstation. Database 38 provides a location for storing treatment order information for multiple patients, patient records and data storage unit 14 provides an alternate store for patient records, as well as other information for hospital information system 10. The information in data storage unit 14 and database 38 is accessed by multiple users from multiple client devices in response to user activation of functions via the treatment order search and selection menus of FIGS. 2-9. Alternatively, patient records may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

In response to, user selection of buttons in the treatment order search and selection menus of FIGS. 2-9, a user is able to access collated data indicating desired treatment order information from database 38. A configuration and authorization function within processor 30 (FIG. 1) determines whether a user is authorized to access treatment order information and to select and sign orders for a particular patient. Patient record information in databases 14 and 38 and departmental systems 22 may be stored in a variety of file formats and includes data indicating treatment orders, medications, images, clinician summaries, notes, investigations, correspondence, laboratory results, etc

The first local area network (LAN) 16 (FIG. 1) provides a communication network among the client device 12, the data storage unit 14 and the server device 18. The second local area network (LAN) 20 provides a communication network between the server device 18 and the departmental systems 22. Departmental systems 22 are systems that need access to information or provide information related to the health and/or welfare of patients in the care of the healthcare provider. Examples of the departmental systems 22 include, a lab system 44, a pharmacy system 46, a financial system 48 and a nursing system 50, as shown in FIG. 1, but may also include a records system, a radiology system, an accounting system, a billing system, and any other system required or desired in a healthcare information system.

The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN). The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 may be wired or wireless and adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

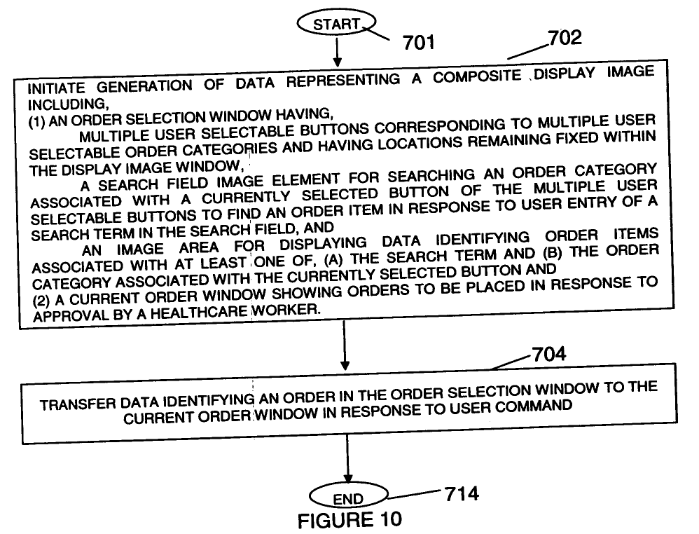

FIG. 10 shows a flowchart of a process performed by UI system 40 operating in conjunction with order entry system 42 (FIG. 1) for providing the treatment search and selection menus and functions of FIGS. 2-9. In Step 702 following the start at step 701, systems 40 and 42 initiate generation of data representing a composite display image. The composite display image includes a treatment order selection window (e.g., window 200 of FIG. 2) displayed in the foreground of the composite display image and a current treatment order window. The treatment order selection window contains user selectable buttons corresponding to multiple user selectable treatment order categories. The button locations remain fixed within the treatment order selection window in different menu configurations of window 200 (displayed in response to selection of different buttons in column 202 of FIG. 2). The treatment order selection window 200 also contains a search field image element for searching a treatment order category associated with a currently selected button of the multiple user selectable buttons to find a treatment order item in response to user entry of a search term in the search field. An image area (289 of FIG. 2) in the treatment order selection window displays data identifying treatment order items associated with at least one of, (a) the search term and (b) the treatment order category associated with the currently selected button.

The user selectable button locations remain fixed within the treatment order selection window following update of the treatment order selection window in response to user selection of a different button of the multiple user selectable buttons. Further, the multiple user selectable treatment order categories comprise items associated with stored treatment order sets associated with at least one of, (a) admission, discharge or transfer, (b) allergies, (c) nursing, (d) diet, (e) sleep, (f) laboratory testing, (g) radiology and (h) medication. The multiple user selectable treatment order categories may also comprise items associated with at least one of, (i) a medical problem, (ii) IV fluids, (iii) tests and (iv) consultation. The treatment order selection window includes multiple image elements associated with corresponding multiple sub-categories (e.g., sub-categories indicated in list 272 of FIG. 2) of a category (indicated in list 202) of user selectable treatment orders. The treatment order selection window enables a user to filter and refine treatment order items associated with the search term and the treatment order category associated with the currently selected button, to provide a subset of treatment order items for identification in the image area in the treatment order selection window.

The treatment order selection window includes multiple image elements enabling a user to filter and refine treatment order items to exclude uncommon items and items that are unassociated with a favorites category. The favorites category comprises at least one of, (a) items favored by a particular healthcare worker, (b) items favored by a clinical specialty and (c) items favored by a healthcare department. The current treatment order window (e.g., window 550 of FIG. 5) in the composite display image shows orders to be placed in response to approval by a healthcare worker. In another embodiment the current treatment order window comprises an existing order window showing existing orders already approved by a healthcare worker.

In step 704, systems 40 and 42, in response to user command, transfer data identifying a treatment order in the treatment order selection window to the current treatment order window showing treatment orders to be placed in response to approval by a clinician. Also system 40 updates the current treatment order window with treatment orders selected via the treatment order selection window. The process of FIG. 10 may comprise machine readable instruction incorporated in a tangible storage medium and executable by a processing device. The process of FIG. 10 ends at step 714.

The system provides an integral part of a computerized physician order entry system in the medical field and is usable in other fields where single categorized items are to be found and selected. The system, process and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any the functions provided by the system and process of FIGS. 1 and 10, may be implemented in hardware, software or a combination of both.

What is claimed is:

1. A user interface system enabling a user to select items for addition to a treatment order list, said items being for use in treating a patient, comprising:
a display processor for initiating generation of data representing a treatment order selection window including,
a plurality of user selectable buttons corresponding to a plurality of user selectable treatment order categories and having locations remaining fixed within said treatment order selection window,
a search field image element for searching a treatment order category associated with a currently selected button of said plurality of user selectable buttons to find a treatment order item in response to user entry of a search term in said search field, and
an image area for displaying data identifying treatment order items associated with at least one of, (a) said search term and (b) said treatment order category associated with said currently selected button.

2. A system according to claim 1, wherein
said treatment order selection window includes a plurality of image elements associated with a corresponding plurality of sub-categories of a category of user selectable treatment orders and enabling a user to filter and refine treatment order items associated with said at least one of, (a) said search term and (b) said treatment order category associated with said currently selected button, to provide a subset of treatment order items for identification in said image area.

3. A system according to claim 1, wherein
said treatment order selection window includes a plurality of image elements enabling a user to filter and refine treatment order items to exclude at least one of, (a) uncommon items and (b) items that are unassociated with a favorites category.

4. A system according to claim 3, wherein
said favorites category comprises at least one of, (a) items favored by a particular healthcare worker, (b) items favored by a clinical specialty and (c) items favored by a healthcare department.

5. A system according to claim 1, wherein
said display processor initiates generation of data representing a composite display image including said treatment order selection window together with at least one of, (a) a current order session window used for showing orders to be placed in response to approval by a clinician and (b) an existing order window showing existing orders already approved by a clinician.

6. A system according to claim 5, wherein
said treatment order selection window is displayed in the foreground of said composite display image.

7. A system according to claim 1, wherein
said plurality of user selectable treatment order categories comprise items associated with at least one of, (a) admission, discharge or transfer, (b) allergies, (c) nursing, (d) diet, (e) sleep, (f) laboratory testing, (g) radiology and (h) medication.

8. A system according to claim 1, wherein
said plurality of user selectable treatment order categories comprise items associated with stored treatment order sets.

9. A system according to claim 1, wherein
said plurality of user selectable treatment order categories comprise items associated with at least one of, (a) a medical problem, (b) IV fluids, (c) tests and (d) consultation.

10. A system according to claim 1, wherein
said display processor updates a current treatment order window with treatment orders selected via said treatment order selection window, said current treatment order window being used for showing treatment orders approved by a clinician.

11. A system according to claim 1, wherein
said user selectable button locations remain fixed within said treatment order selection window following update of said treatment order selection window in response to user selection of a different button of said plurality of user selectable buttons.

12. A method for providing a user interface enabling a user to select items for addition to a treatment order list, said items being for use in treating a patient, comprising the activities of:
initiating generation of data representing a treatment order selection window including,
a plurality of user selectable buttons corresponding to a plurality of user selectable treatment order categories and having locations remaining fixed within said treatment order selection window,
a search field image element for searching a treatment order category associated with a currently selected button of said plurality of user selectable buttons to find a treatment order item in response to user entry of a search term in said search field, and
an image area for displaying data identifying treatment order items associated with at least one of, (a) said search term and (b) said treatment order category associated with said currently selected button.

13. A tangible storage medium including machine readable instruction for executing the method of claim 12.

14. A user interface system enabling a user to select items for addition to a treatment order list, said items being for use in treating a patient, comprising:
a display processor for initiating generation of data representing a composite display image including,
a treatment order selection window having,
a plurality of user selectable buttons corresponding to a plurality of user selectable treatment order categories and having locations remaining fixed within said treatment order selection window,
a search field image element for searching a treatment order category associated with a currently selected button of said plurality of user selectable buttons to find a treatment order item in response to user entry of a search term in said search field, and
an image area for displaying data identifying treatment order items associated with at least one of, (a) said search term and (b) said treatment order category associated with said currently selected button and
a current treatment order window showing treatment orders to be placed in response to approval by a healthcare worker.

15. A system according to claim 14, wherein
said current treatment order window shows existing treatment orders already approved by a healthcare worker.

16. A system according to claim 14, wherein
said display processor transfers data identifying a treatment order in said treatment order selection window to said current treatment order window in response to user command.

17. A system according to claim 14, wherein
said treatment order selection window is displayed in the foreground of said composite display image.

18. A system according to claim 14, wherein
said user selectable button locations remain fixed within said treatment order selection window following update of said treatment order selection window in response to user selection of a different button of said plurality of user selectable buttons.
